(19) United States
(12) Patent Application Publication
(10) Pub. No.: US 2011/0120499 A1
(43) Pub. Date: May 26, 2011

(54) Method and System for an Injectable Foam Pig

(76) Inventors: Rick D. Pruett, Anchorage, AK (US); Eric N. Freeman, Kiefer, OK (US); Phillip K. Morrison, Broken Arrow, OK (US); Brad E. McSweeny, Tulsa, OK (US)

(21) Appl. No.: 12/625,169

(22) Filed: Nov. 24, 2009

(51) Int. Cl. B08B 9/00

(52) U.S. Cl. 134/22.12; 15/104.062

(57) ABSTRACT

This invention relates to a method and system for inserting a larger diameter foam pig into a tubular member, such as a pipe or pipeline, through a smaller diameter access connection when the tubular member contains a pressurized product flow. A foam pig sized appropriately for the tubular member is reduced in size so as to reside within a canister or vacuum-packed bag within the canister. The canister is located above an access connection to the tubular member. The reduced size foam pig is then injected from the canister through the small diameter access connection. As the foam pig enters into the interior space of the tubular member, the pig expands and turns and travels downstream of the access connection. The expanded foam pig has a diameter substantially equal to that of the tubular member and a volume substantially greater than that of the foam pig prior to its injection.

### BACKGROUND OF THE INVENTION

This invention relates generally to apparatuses and methods for servicing piping and pipelines. More particularly, the invention relates to foam pigs which are inserted into the interior of a pipeline and are moved through the pipeline under differential pressure.

Foam pigs—made of plastic, polyurethane, or rubber material—are well known in the pipeline industry. Foam pigs, which are used for light duty cleaning of interior of pipes, are pre-formed and normally inserted into and removed from the pipeline at their full diameter through an access connection located at both ends of the pipeline. However, many applications arise that require a pig to be inserted and run mid-way of a pipeline section or into a pipeline section for which no same-sized pig launching system exits. These applications require expensive installation of pigging equipment. Additionally, for large diameter pipelines if the access connection for the foam pig must be substantially the same size as that of the pipeline, significantly greater cost is incurred by the pipeline operator in installing that access connection. A need exists for a foam pig that can be inserted through a significantly smaller diameter access connection—which opens into a much larger diameter pipeline—without incurring damage to the foam pig during the insertion process and reduces the cost associated with the installation of conventional pigging equipment.

### SUMMARY OF THE INVENTION

This invention relates to a method and system for inserting or injecting a large diameter, preformed foam (slug) pig through a small diameter opening in a pipe or pipeline when the pipeline contains a pressurized product flow. The method includes the step of reducing the size or volume of the large diameter foam pig so that it can reside within a small diameter canister—or within a vacuum-packed bag housed within the canister—and injecting the reduced volume pig from the canister, through an access connection or branch fitting to the pipeline, and into an interior space of the larger diameter pipeline. As the foam pig is forced out of the canister and extruded into the interior space of the pipeline, the foam pig begins to significantly expand in diameter and volume and turns and travels downstream of the branch fitting, thereby reforming itself into its original (preferably cylindrical) shape, volume, and diameter and conforming to the pipeline. The method further includes the step of equalizing pressure between the branch fitting and the pipeline prior to the insertion step.

A system for inserting the foam pig into a pipeline includes a means for significantly reducing the volume of a large diameter foam pig prior to it being deposited into the pipeline so that the foam pig can reside within a small diameter canister connected to an access connection or branch fitting of the pipeline. The system also includes a means for injecting this reduced volume foam pig into the interior space of the pipeline. The injection means may be a mechanical, hydraulic or pneumatic ram, or differential pressure, or some combination thereof. One or more sandwich-style valves may be interposed between the ram and a pipe or canister containing the foam pig material and between the canister and the branch fitting of the pipeline. Means are provided for equalizing pressure between the branch fitting and the pressurized product flow prior to injecting the foam pig from the canister into the pipeline.

An object of this invention is to effectively introduce a large diameter foam pig into a pipeline through a significantly smaller diameter opening to the pipeline in order to clean the pipeline or separate product (or both). Another object of this invention is to provide an expandable foam pig that is pre-formed but significantly reduced in volume by vacuum packing or other means prior to its insertion into the pipeline. Yet another object of this invention is to introduce the foam pig in a pipeline containing a pressurized product flow. Still yet another object of this invention is to provide a means for injecting the form pig into the pipeline. A further object of this invention is to provide a foam pig that requires substantially less space to transport to the job site as compared to the final volume and size of the pig when deployed in the main pipeline. Another object of this invention is to provide a foam pig that requires a relatively small-diameter access connection as compared to the diameter of the main pipeline. Still yet another object of this invention is to provide a less expensive installation for inserting a foam pig into a section of pipeline having no pre-existing access connection or existing but smaller branch fitting connections. Another object of this invention is to provide a foam pig system that could be used in place of gel pigs. A final object of this invention is to provide a foam pig that returns to its original shape, volume, and diameter while residing in the pipeline

### BRIEF DESCRIPTION OF THE DRAWINGS

FIG. 1 is cross-sectional view of a main tubular member having a smaller diameter branch fitting affixed to it that provides an access connection to the interior of the tubular member such as a pipe or pipeline. A foam (slug) pig of the size required to clean the interior of the tubular member, or separate product within the tubular member, is compacted or reduced in size so as to reside within a smaller diameter housing or canister mounted to the branch fitting. The foam pig may be contained within a vacuum-packed bag that is placed inside the canister.

FIG. 2 is a view of the arrangement of FIG. 1 further including means for forcing or injecting the foam pig out of the canister, through the branch fitting, and into the interior space of the pipeline. The injection means may be a mechanical, hydraulic or pneumatic ram, or differential pressure, or some combination thereof.

FIG. 3 is a view of the arrangement of FIG. 2 further including sandwich-style valves placed between the canister and branch fitting and between the injection means and the canister.

FIG. 4 is view of the arrangement of FIG. 3 further including equalization piping for equalizing pressure between the branch fitting and a pressurized product flow in the pipeline. Because of the product flow, the foam pig travels downstream of the branch fitting as the foam pig is extruded into or enters the interior space of the pipeline. In cases in which the foam pig is stored in a bag, a bag ripper may be located in the interior of the branch fitting to puncture the bag and permit the release of the foam pig into the interior space of the pipeline.

FIG. 5 is a view of the foam pig after it has been expanded, returned to its original shape, volume, and diameter, and conformed to the pipeline. The cylindrical-shaped foam pig has a diameter substantially equal to that of the pipeline and a volume significantly greater than when it resided in the canister prior to its injection into the pipeline.

FIG. 6 illustrates the foam pig prior to vacuum-compacting or packing.

FIG. 7 illustrates the foam pig of FIG. 6 after vacuum-compacting or packing. The foam pig is reduced in size and volume significantly smaller than that of its original diameter and volume and sufficient for the pig to reside within the canister of FIGS. 1-5.

### DETAILED DESCRIPTION OF THE PREFERRED EMBODIMENTS

Preferred embodiments of a method and system for inserting a foam pig into a tubular member, such as a pipe or pipeline, when the tubular member contains a pressurized product flow will now be described by making reference to the drawings and the following elements illustrated in the drawings:
10 Injectable foam pig system
20 Tubular member (pipe or pipeline)
22 Branch fitting/access connection
24 Access hole
26 Interior space
28 Valve
30 Housing/canister
32 Bag or pack
33 Bag punch
34 Equalization piping
36 Valve
38 External coupler
40 Injection means
42 Ram or plunger
44 Housing
50 Foam (slug) pig

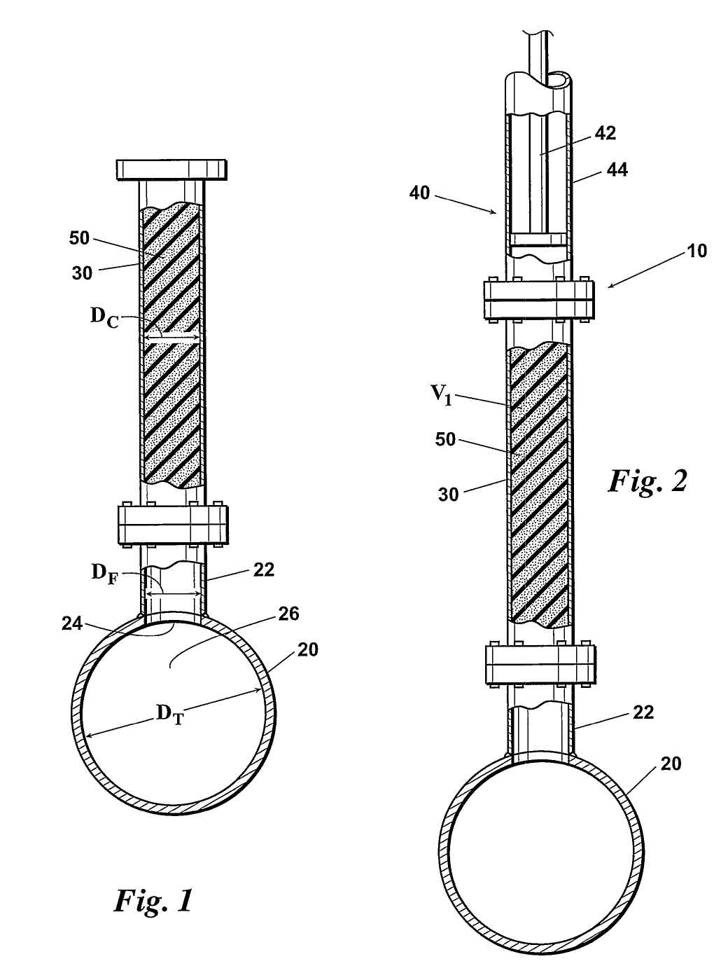

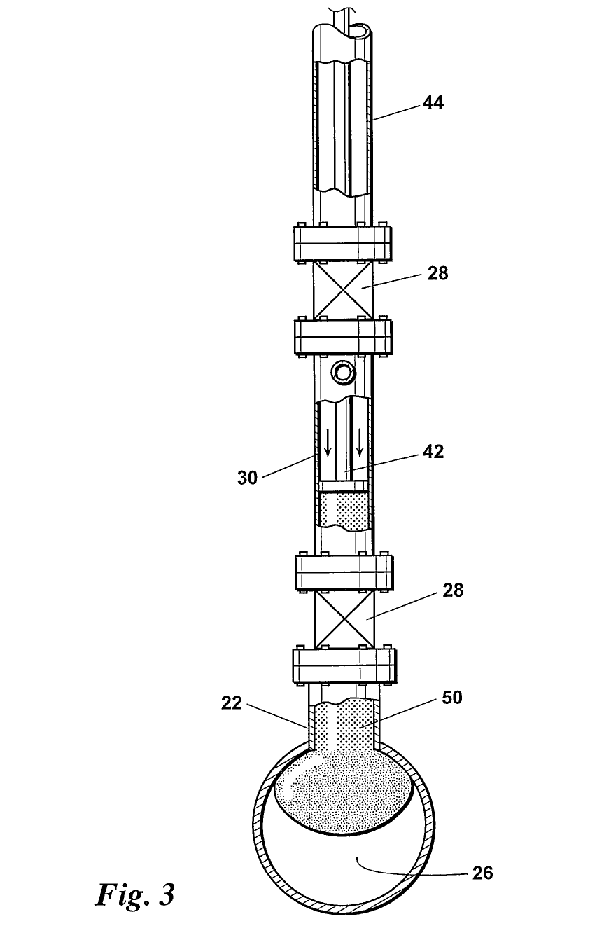

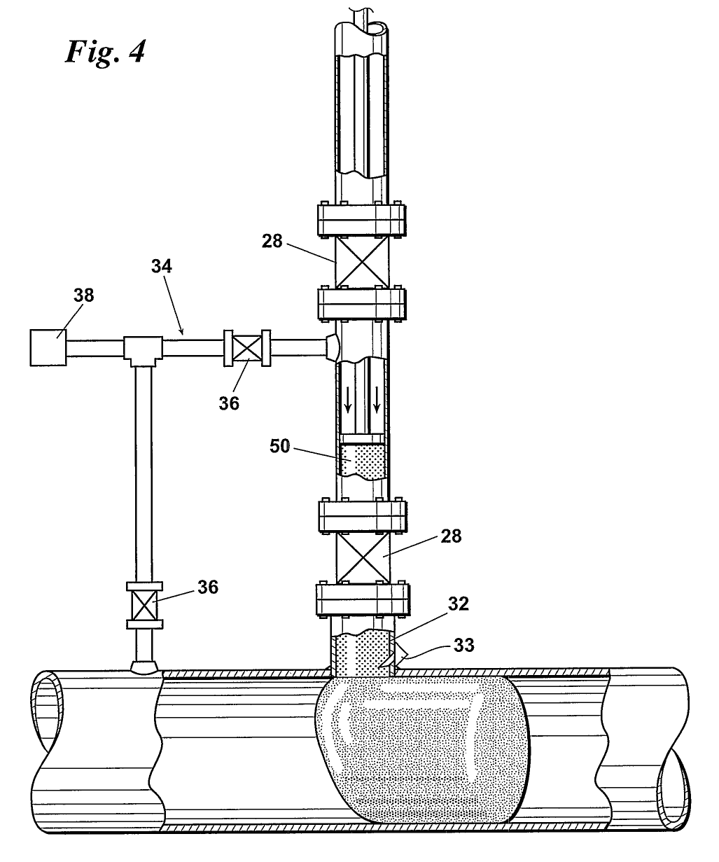

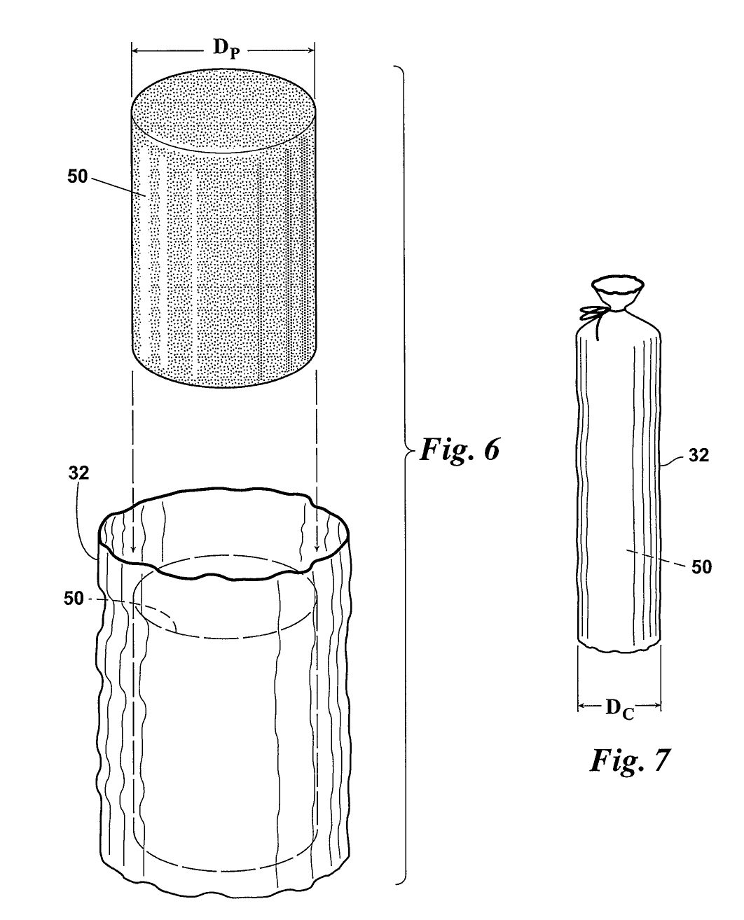

Referring to the drawings and first to FIGS. 1 & 2, a tubular member 20 having an inside diameter “D_{T}” is fitted with a branch fitting 22 or similar access connection having an inside diameter “D_{F}”. Branch fitting 22 provides an access hole 24 to the interior space 26 of tubular member 20. Means of providing access hole 24 are well known in the piping and pipeline industry. A valve 28 is typically fitted above branch fitting 22 and closed to prevent pressurized product flow from escaping through access hole 24 when branch fitting 22 is not being used to access interior space 26 (see FIG. 3). Preferably, the diameter D_{F} of branch fitting 22 is substantially smaller than the diameter D_{T} of tubular member 20 in order to reduce the space requirements and cost of tapping into tubular member 20 and to reduce the size, cost, and weight of injectable foam pig system 10. System 10 includes a housing or canister 30 secured above branch fitting 12, a foam (slug) pig 50 that has been compacted or reduced in size to a volume V₁, and a means 40 for injecting the foam pig 50 into the interior space 26 of tubular member 20. Foam pig 50 may be a pre-compacted or pre-vacuum packed foam pig contained in a vacuum-packed bag 32 (see e.g., FIGS. 4, 6 & 7). In one preferred embodiment, foam pig 50 is vacuum-compacted to about one-third of its original diameter and volume so that, when compacted, its diameter is slightly smaller than the diameter “Dc” of canister 30 in order to be received by canister 30 (see e.g., FIGS. 1 & 7).

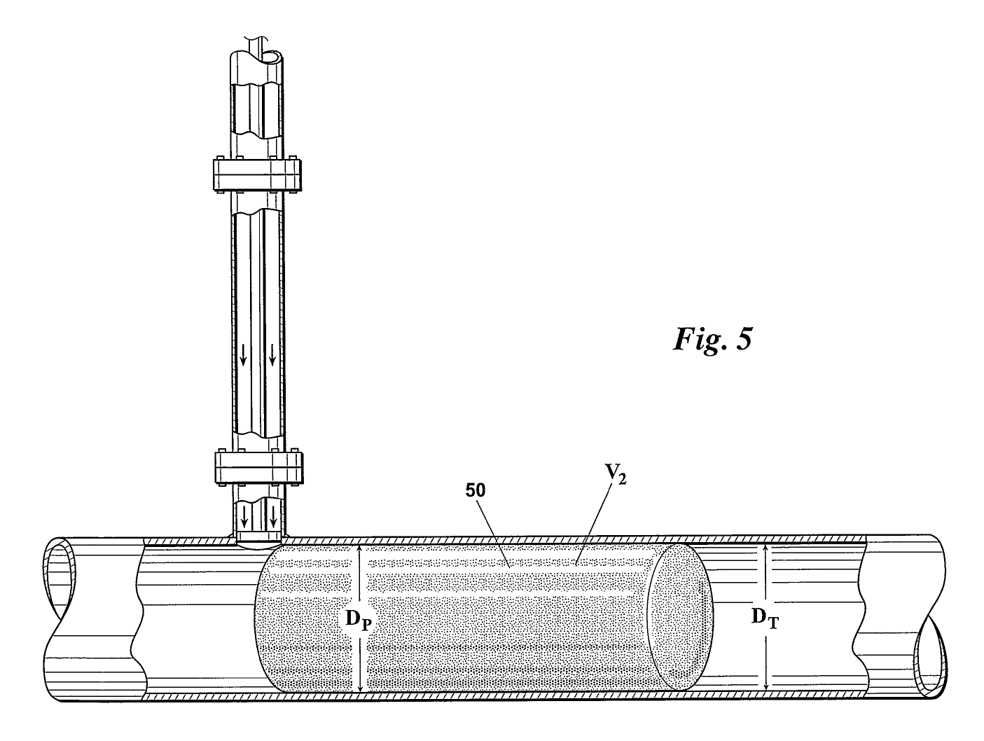

Canister 30 may be pre-loaded with foam pig 50 and transported to the job site as a complete unit or foam pig 50 may be transported independent of canister 30 and loaded into the canister 30 at the job site. Foam pig 50 is made of a foam material well known in the art for forming foam pigs. Canister 30 may be specifically sized to accommodate foam pig 50 and based upon such factors as the relationship between diameter D_{T} of tubular member 10 and diameter D_{A} of branch fitting 22, the desired finished size and length of the foam pig 50 (see FIG. 5), and the compactability and expandability of foam pig 50. The diameter D_{C} of canister 30 may be smaller than that of D_{F}, with branch fitting 22 serving as either a tapered or non-tapered expansion-type fitting in order to allow foam pig 50 an easier transition into interior space 26.

Referring to FIGS. 2 to 4, an injection means 40 for forcing or injecting foam pig 50 through access hole 24 and into interior space 26 is located above canister 30. In a preferred embodiment, injection means 40 is a ram or plunger 42 received by a housing 44 and having sufficient stroke length to travel the length of canister 30 and branch fitting 22, thereby forcing foam pig 50 through access hole 24. Ram 42 may be a mechanical, hydraulic or pneumatic ram. Equalization piping 34 with isolation valves 36 is provided to equalize the pressure between canister 30 and the pressurized product flow contained in tubular member 20. Equalization piping 34 may include an external coupler 38 to apply additional differential pressure to assist ram 42. For example, ram 42 may be nitrogen gas-assisted. A second valve 28 is also located between the lower end of housing 44 and the upper end of canister 30. The valves 28 provide for added safety and isolation of system 10.

As ram 42 begins its downward travel, foam pig 50 is forced downward and through access hole 24. A bag punch or ripper 33 may be located at a lower end of branch fitting 12 to puncture bag 32 (if used) and allow foam pig 50 to be released from bag 32. (Alternatively, bag 32 may be punctured prior to its insertion into canister 30.) As foam pig 50 is extruded into or enters interior space 26, it begins to expand substantially instantaneously and toward the inner walls of tubular member 20. Because of the pressurized product flow flowing through interior space 26, as foam pig 50 expands it also turns and travels downstream of access hole 24. If tubular member 20 contains no product flow, means for directing foam pig 50 downstream of access hole 24, such as a shoe horn-type arrangement (not shown), must be provided.

Referring now to FIG. 5, ram 42 continues its downward travel until it reaches the bottom of its stroke, at which time substantially all of foam pig 50 resides within interior space 26. Ram 42 may then be retracted and the valves 28 closed in turn. Foam pig 50 preferably forms a cylindrical-shaped foam pig 50 having a volume V₂ that is substantially greater than that of volume V₁ and a diameter “D_{P}” that is substantially equal to that of diameter D_{T} of tubular member 20 (see also FIG. 6). In a preferred embodiment, volume V₂ is about 1½ to 4 times that of volume V₁. Expanded foam pig 50 then moves forward under differential pressure through the interior space 26 of tubular member 20.

While a method and system for inserting a foam pig into a tubular member has been described with a certain degree of particularity, many changes may be made in the details of construction and the arrangement of components without departing from the spirit and scope of this disclosure. A method and system according to this disclosure, therefore, is limited only by the scope of the attached claims, including the full range of equivalency to which each element thereof is entitled.

What is claimed is:

1. A method for inserting a foam pig into a tubular member containing a product flow under pressure, the method comprising the step of injecting a foam pig into the interior space of a tubular member;
wherein the foam pig has a volume “V₁” prior to said injecting step and a volume “V₂” after said injecting step, volume V₂ being greater than volume V₁.

2. A method according to claim 1 wherein the volume V₂ is in a range of 1½ to 4 times greater than the volume V₁.

3. A method according to claim 1 wherein the foam pig after said injecting step has a diameter substantially equal to that of the interior space of the tubular member.

4. A method according to claim 1 further comprising the step of compacting a size of the foam pig to the volume V₁ from the volume V₂ prior to said injecting step.

5. A method according to claim 4 wherein a diameter of the foam pig after said compacting step is less than the diameter of the interior space of the tubular member.

6. A method according to claim 1 further comprising the step of equalizing a pressure between an access connection to the tubular member and a pressurized product flow with the tubular member prior to said injecting step.

7. A method according to claim 1 wherein the foam pig prior to said injecting step is contained within a canister.

8. A method according to claim 1 wherein the foam pig prior to said injecting step is contained within a bag.

9. A method according to claim 8 wherein said injecting step further comprises the sub-step of puncturing the bag to provide a means of escape for the foam pig contained within the bag.

10. For use in a tubular member, an injectable foam pig comprising:
a foam pig being disposed within an access connection to a tubular member and having a volume “V₁”; and
means for injecting said foam pig through an access hole and into an interior space of the tubular member;
said foam pig expanding as it enters the interior space of the tubular member to a final diameter substantially equal to that of the interior space of the tubular member;
said expanded foam pig having a volume “V₂” greater than said volume V₁.

11. An injectable foam pig according to claim 10 wherein the tubular member includes a pressurized product flow.

12. An injectable foam pig according to claim 11 wherein said injection means includes means for equalizing a pressure between the access connection and the pressurized product flow.

13. An injectable foam pig according to claim 10 wherein said foam pig travels downstream of the access connection as said foam pig enters the interior space of the tubular member.

14. An injectable foam pig according to claim 10 wherein said injection means is a ram disposed above and received by the access connection.

15. An injectable foam pig according to claim 10 wherein the access connection includes a canister containing said foam pig having said volume “V₁.

16. An injectable foam pig according to claim 10 wherein the access connection includes a bag containing said foam pig having said volume “V₁.

17. An injectable foam pig according to claim 16 further comprising the access connection including means for puncturing said bag.

18. An injectable foam pig according to claim 10 wherein the access connection includes an expansion fitting disposed above the access hole.

19. An injectable foam pig according to claim 10 wherein said volume V₂ is in a range of 1½ to 4 times greater than said volume V₁.

20. An injectable foam pig according to claim 10 wherein a diameter of the access connection is less than the diameter of the interior space of the tubular member.
